(19) United States
(12) Patent Application Publication
(10) Pub. No.: US 2014/0148155 A1
(43) Pub. Date: May 29, 2014

(54) METHOD AND APPARATUS FOR IMPLEMENTING TRANSMIT BEAMFORMING

(71) Applicant: MOTOROLA SOLUTIONS, INC., Schaumburg, IL (US)

(72) Inventors: Puneet Batta, San Jose, CA (US); Tarun Maharana, Sunnyvale, CA (US)

(73) Assignee: Motorola Solutions, Inc., Schaumburg, IL (US)

(21) Appl. No.: 13/686,968

(22) Filed: Nov. 28, 2012

(51) Int. Cl. H04W 8/02

(52) U.S. Cl. CPC H04W 8/02
USPC 455/432.1

(57) ABSTRACT

One of a first access point associated with the first coverage area or the client device in the first coverage area determines that the client device is likely to roam to the second coverage area. A beamforming link is established between the client device and a second access point associated with the second coverage area. Sounding data is exchanged between one of the first access point or the client device and the second access point, wherein the sounding data is used by the second access point and the client device to calculate a steering matrix for the beamforming link between the client device and the second access point. After roaming to the second coverage area, the client device associates with the second access point and the client device and the second access point perform beamforming on the beamforming link.

### FIELD OF THE DISCLOSURE

The present disclosure relates generally to implementing transmit beamforming techniques, and more particularly, to implementing transmit beamforming techniques when a client device is roaming between coverage areas supported by different access points.

### BACKGROUND

The Institute of Electrical and Electronics Engineers (IEEE) 802.11n standard improves upon the previous 802.11 standards by adding multiple-input multiple-output (MIMO) techniques which use multiple antennas to improve performance in a multipath environment. Any of the IEEE standards or specifications referred to herein may be obtained at IEEE, 445 Hoes Lane, PO Box 1331, Piscataway, N.J. 08855-1331, USA. In particular, one of the MIMO techniques used in the 802.11n standard is transmit beamforming. Beamforming is a wireless transmission technique in which the relative gain and phase of an array of antennas elements can be adjusted so that the antenna beam (pattern) can be directed for receiving or transmitting data. Beamforming can therefore be used to improve reception quality and increase data throughput in a MIMO communication system.

Within a multipath environment, beamforming allows access points and client devices, such as such as a personal computer, video game console, smart phone, tablet, or digital audio player, to concentrate their radio-frequency (RF) energy towards each other. In particular, access points that support beamforming focus the RF energy they radiate directly at a receiving client device. This can be achieved by amplifying and phasing signals using a Wi-Fi chip or by physically focusing the energy using specialized high-gain directional transmit antennas (smart antennas) that can control the propagation pattern of a signal. The purpose of either implementation is to improve signal reception at the client device and, as a result, increase throughput. In noisy environments or environments where the distance between the access point and the client is relatively large, beamforming helps in providing much better throughput and quality of service because the two end points (the access point and the client device) can ‘hear’ each other better.

Transmit beamforming requires the use of multiple antenna elements at a transmitter (access point) and a measured wireless channel between the transmitter and a receiver (client device). In some implementations, transmit beamforming using the smart antenna technology to “steer” beams and provide for greater range and throughput relies on the transmitter understanding the characteristics of the MIMO channel, i.e., the measure wireless channel between the access point and the client device. By understanding the MIMO channel, the access point may calculate a steering matrix that is needed to be able to steer a beam in the direction of the client device. In order to characterize the channel correctly, the access point typically receives some feedback from the client device. 802.11n beamforming transmitters try to adjust the phase of the signals based on this feedback. To obtain the necessary feedback, the 802.11n standard defines “explicit beamforming”, wherein a downstream channel is measured at the client device (beamformee) and relayed back to the access point (beamformer) for the beamformer to derive the transmit beamforming parameters from the measured channel information. The 802.11n standard also defines “implicit beamforming”, wherein the upstream wireless channel is measured by the beamformer and the measurement is used to derive the parameters for subsequent downstream beamformed transmission.

In 802.11n, client devices (beamformees) negotiate a beamforming link during association with an access point. After the beamforming link is set up between the client device and the access point, assuming explicit beamforming as specified in the standard is being used, link status information is exchanged between the client device and the access point using periodic exchanges of sounding packets. In particular, a periodic request frame is sent from the access point to the client device (beamformee) for the client device to respond with a sounding Presentation Protocol Data Unit (PPDU). Based on the received sounding PPDUs, the beamformer performs over-the-air calibration of radios and uses the sounding PPDUs as a feedback mechanism to estimate the measured wireless channel and calculate the steering matrix.

Depending on changes in the client device's location relative to the access point and the RF environment of the beamforming link and surroundings, the data-points for the beamforming link may keep changing and newer sounding PPDUs are needed to continuously ‘fine-tune’ the link. The actual steering matrix that is used to converge the beam is derived from the changing data points. This process works well in a single transmitter-receiver environment. However, when the client device roams to another coverage area supported by another access point, the beamforming link with the current access point is torn down and a new beamforming link to a new access point needs to be established. After the client device associates with the new access point, the beamforming link is negotiated with the new access point. Until sufficient sounding PPDUs are exchanged between the new access point and the client device, the new link is not yet at its optimal efficiency and performance. During this time, the new access point may be unable to perform transmit beamforming is on the channel between the new access point and the client device, resulting in relatively poorer reception quality for information exchanged between the client device and the new access point and decreased data throughput.

Accordingly, there is a need for method and apparatus for implementing transmit beamforming techniques when a client device is roaming between coverage areas supported by different access points.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a system which uses multiple-input multiple-output (MIMO) techniques in accordance with some embodiments.

FIG. 2 is a block diagram of a system where a client device associated with a first access point establishes a beamforming link with another access point in accordance with some embodiments.

FIG. 3 is another block diagram of a system where a client device is likely to roam from a first access point to another access point in accordance with some embodiments.

FIG. 4 is a flow diagram of how a client device pre-establishes a beamforming link with an access point in accordance with some embodiments.

FIG. 5 is another flow diagram of how a client device pre-establishes a beamforming link with an access point in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Some embodiments are directed to methods and apparatuses for pre-establishing a beamforming link between a client device in a first coverage area and an access point associated with a second coverage area, prior to the client device roaming to the seconding coverage area. One of a first access point associated with the first coverage area or the client device in the first coverage area determines that the client device is likely to roam to the second coverage area. A beamforming link is established between the client device and a second access point associated with the second coverage area. Sounding data is exchanged between one of the first access point or the client device and the second access point, wherein the sounding data is used by the client device and the second access point to successfully calculate a steering matrix for the beamforming link between the client device and the second access point. After roaming to the second coverage area, the client device associates with the second access point and beamforming is performed by the client device and the second access point on the beamforming link.

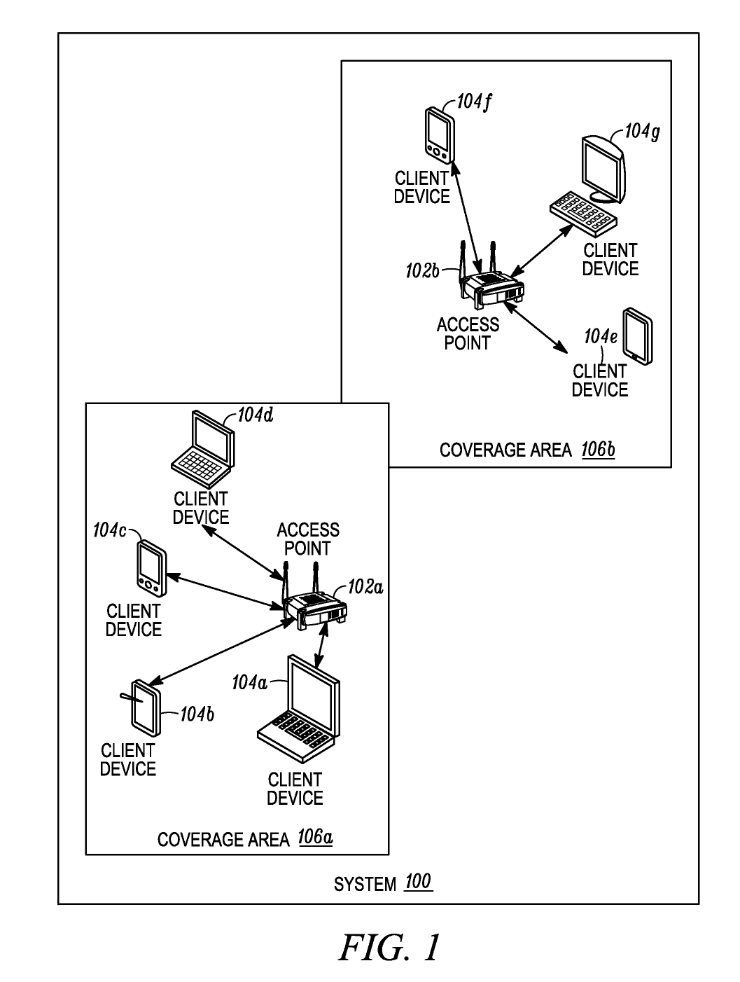

FIG. 1 is a block diagram of a system which uses multiple-input multiple-output (MIMO) techniques in accordance with some embodiments. System 100 may include access points 102, each of which is configured to communicate directly with a wirelessly connected/associated client device 104 within a coverage area 106 supported by the access point. For example, access point 102a is configured to communicate directly with client devices 104a-104d in coverage area 106a and access point 102b is configured to communicate directly with client devices 104e-104g in coverage area 106b. Each of the access points 102 and client devices 104 operate in accordance with the Institute of Electrical and Electronics Engineers (IEEE) 802.11n standard and may use multiple antennas to improve performance in a multipath environment. Any of the IEEE standards or specifications referred to herein may be obtained at IEEE, 445 Hoes Lane, PO Box 1331, Piscataway, N.J. 08855-1331, USA.

Client devices 104 may be, for example, a personal computer, video game console, smart phone, tablet, or digital audio player. In general, client device 104 is any electronic device that can communicate with an access point. System 100 may implement multiple access techniques, such as Orthogonal Frequency-Division Multiple Access (OFDMA), that allow different client devices 104 to share an available bandwidth by allotting to each client device a fraction of the system resources. Other access techniques may be used in some embodiments. Other components of system 100 are not shown for ease of illustration.

Each access point 102 may communicate with an associated client device 104 using transmit beamforming. In transmit beamforming, each access point 102 uses multiple antenna elements to transmit signals to an associated client device and each access point 102 measures a wireless channel between the access point and the associated client device 104. Within a multipath environment, beamforming allows each access point 102 and the client devices associated with the access point 102 to concentrate their radio-frequency (RF) energy towards each other. For example, access point 102a that supports beamforming can focus its RF energy directly at, for example client device 104a. In some embodiments, access point 102a can focus its RF energy at client device 104a by using a Wi-Fi chip to amplify and phase signals. In other embodiments, access point 102a can physically “steer” its RF energy using specialized high-gain directional transmit antennas (smart antennas) that can control the propagation pattern of a signal.

In embodiments where, for example, access point 102a uses the smart antenna technology to “steer” beams to each of client devices 104a-104d, transmit beamforming provides for greater range and throughput and results in constructive multipath communication. This leads to a higher signal-to-noise (SNR) ratio and the amplitude of the received signal at each of client devices 104a-104d is relative greater, resulting in greater range for individual client devices communicating with access point 102a. In order for access point 102a to perform transmit beamforming with, for example, client device 104a, access point 102a has to understand the characteristics of a MIMO channel between access point 102a and client device 104a. Understanding the characteristics of the MIMO channel allows access point 102a and client device 104a to calculate a steering matrix needed to be able to steer a beam in the direction between access point 102a and client device 104a.

In some embodiments, to correctly characterize or measure the MIMO channel between access point 102a and client device 104a, access point 102a typically receives some feedback from client device 104a. Access point 102a tries to adjust the phase of the signals directed to client device 104a based on the feedback from client device 104a. Access point 102a may obtain the necessary feedback by “implicit beamforming”, wherein the upstream wireless channel from client device 104a to access point 102a is measured by the access point 102a and the measurement is used to derive the parameters for subsequent downstream beamformed transmission(s) from access point 102a to client device 104a. Implicit beamforming has the advantage that client device 104a does not need to measure and send the channel state information to access point 102a, although calibration information may be exchanged between the access point 102a and client device 104a.

Access point 102a may also obtain the necessary feedback by “explicit beamforming”, wherein a downstream channel (from access point 102a to client device 104a) is measured at client device 104a and relayed back to access point 102a for access point 102a and/or client device 104a to derive the transmit beamforming parameters from the measured channel information. In this scenario, access point 102a may be described as a beamformer and client device 104a may be described as a beamformee.

In some embodiments, upon initially entering a MIMO system, a client device negotiates the usage of beamforming during association with an access point. Accordingly, during initial setup, client devices 104a-104d (beamformees associated with access point 102a) negotiate the usage of beamforming during association with access point 102a, and client devices 104e-104g (beamformees associated with access point 102b) negotiate the usage of beamforming during association with access point 102b. After, for example, client device 104a associates with access point 102a and a beamforming link is set up between access point 102a and client device 104a, assuming explicit beamforming is being used, link status information is exchanged between access point 102a and client device 104a, using periodic exchange of sounding packets. The sounding packets may be either compressed or non-compressed. In particular, access point 102a may send a periodic frame request for a sounding Presentation Protocol Data Unit (PPDU) to client device 104a and/or client device 104a may send a periodic frame request for a sounding PPDU to access point 102a. Based on the received sounding PPDUs, access point 102a may perform over-the-air calibration of radios. Access point 102a and client device 104a also may use the received sounding PPDUs as a feedback mechanism to estimate the MIMO channel to calculate a steering matrix. The steering matrix is thereafter used by access point 102a to steer a beam in the direction of client device 104a, and vice versa.

If access point 102a knows about the location of client device 104a, the phase of the multiple signals sent from the MIMO antennas used by access point 102a can be adjusted. When the multiple signals arrive at client device 104a, the signals may be in-phased, resulting in constructive multipath instead of the destructive multipath caused by out-of-phase signals. Carefully controlling the phase of the signals transmitted from multiple antennas has the effect of emulating a high-gain unidirectional antenna or “steering” the beams. The higher SNR also results in fewer layer two retransmissions.

Depending on changes in the location of client device 104a relative to access point 102a and the RF environment of the link and surroundings, the data-points for beamforming may keep changing and access point 102a may need newer sounding frames from client device 104a to continuously ‘fine-tune’ the link between access point 102a and client device 104a. The actual steering matrix used in converging the beam is derived from the changing data points.

When client device 104a is roaming to coverage area supported by different access point, for example access point 102b, a new beamforming link to access point 102b is to be established. In some embodiments, before client device 104a moves to coverage area 106b, a new beamforming link is negotiated between access point 102b and client device 104a. After the beamforming link is set up, assuming explicit beamforming is being used, link status information is exchanged between access point 102b and client device 104a, using periodic exchange of sounding packets. In some embodiments, sufficient sounding packets are exchanged between client device 104a and access point 102b to ensure that access point 102b and client device 104a can successfully calculate a new steering matrix for the new link between client device 104a and access point 102b; and therefore, successfully perform beamforming on the new link before client device 104a moves to coverage area 106b and associates with access point 102b. In some implementations, client device 104a may maintain the link with access point 102a until it moves to coverage area 106b and associates with access point 102b.

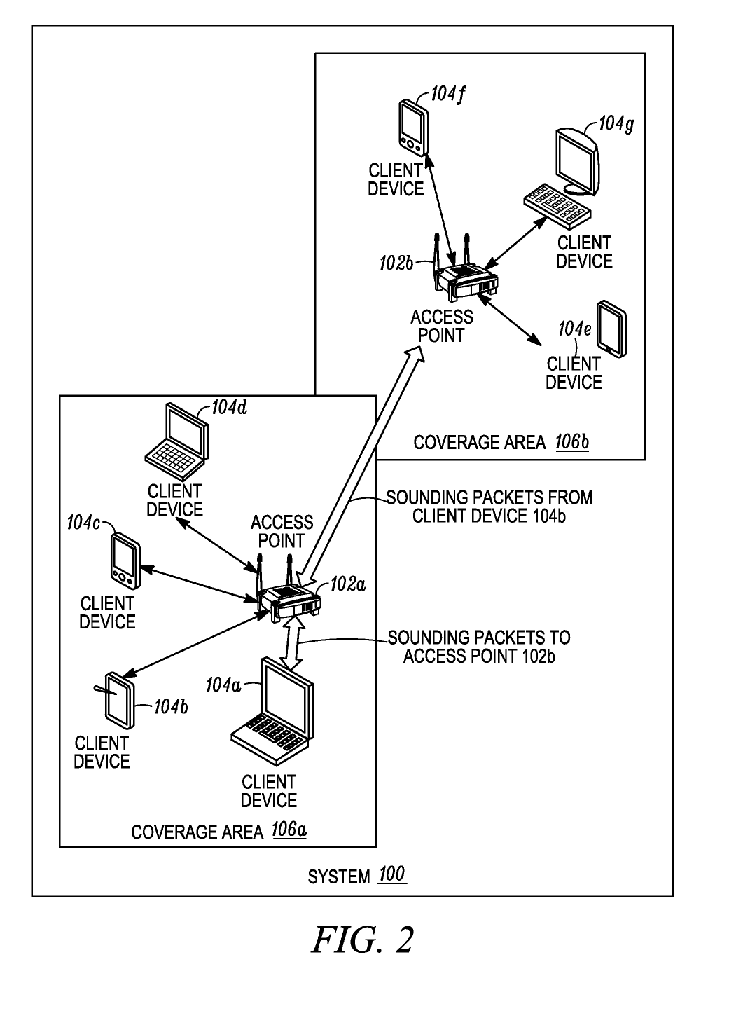

FIG. 2 is a block diagram of system 100 where a client device associated with a first access point establishes a beamforming link with another access point in accordance with some embodiments. In some embodiments, before roaming from coverage area 106a to coverage area 106b, client device 104a may send a frame to access point 102b to indicate to access point 102b that client device 104a intends to roam to coverage area 106b. Access point 102b may thereafter periodically request sounding PPDUs from client device 104a and/or client device 104a may periodically request sounding PPDUs from access point 102a. Responsive to the periodic request(s), client device 104a may start exchanging sounding packets with access point 102b. Access point 102b and client device 104a may use the sounding PPDUs to set up a beamforming steering matrix for the MIMO link between client device 104a and access point 102b. While client device 104a is exchanging sounding packets with access point 102b, client device 104a may still be associated (in communication) with access point 102a and may still be exchanging packets with access point 102a so that there is no loss of service. In other words, before client device 104a actually roams and associates with a new access point (access point 102b), client device 104a may pre-establish a beamforming link with the new access point (access point 102b) with whom it intends to communicate after roaming.

In some embodiments, client device 104a may pre-establish the new beamforming link with access point 102b by exchanging sounding packets with access point 102b through access point 102a. Accordingly, prior to associating with access point 102b, the sounding packets from client device 104a to access point 102b traverse through access point 102a with whom client device 104a is currently associated. Once sufficient sounding packets are exchanged between client device 104a and access point 102b, the beamforming link between client device 104a and access point 102b may be successfully pre-established, i.e., once access point 102b and client device 104a have received sufficient sounding packets to successfully calculate the beamforming steering matrix for the MIMO channel between client device 104a and access point 102b, access point 102b and client device 104a are able to perform beamforming on the link. Thereafter, when client device 104a roams to coverage area 106b and associates with access point 102b, access point 102b can immediately steer its beam to client device 104a, and vice versa, ensuring that there is no degradation in the reception of signals at client device 104a as client device 104a roams between coverage areas.

The advantage of this approach is access point 102b can perform beamforming on signals sent to client device 104a, and vice versa, as soon as client device 104a moves into coverage area 106b and associates with access point 102b. This ensures that the reception quality as client device 104a roams between coverage areas is not decreased. However, pre-establishing the beamforming link has limitations. For instance, information associated with pre-established links may increase the volume of requests handled by the access points. Several known techniques may be used to ensure that an access point is not maintaining a link, for example, for a client device that does not eventually roam. In some implementations, after a pre-determined period, if the client device does not roam to the new coverage area, the access point may drop the link and/or discard information associated with the link.

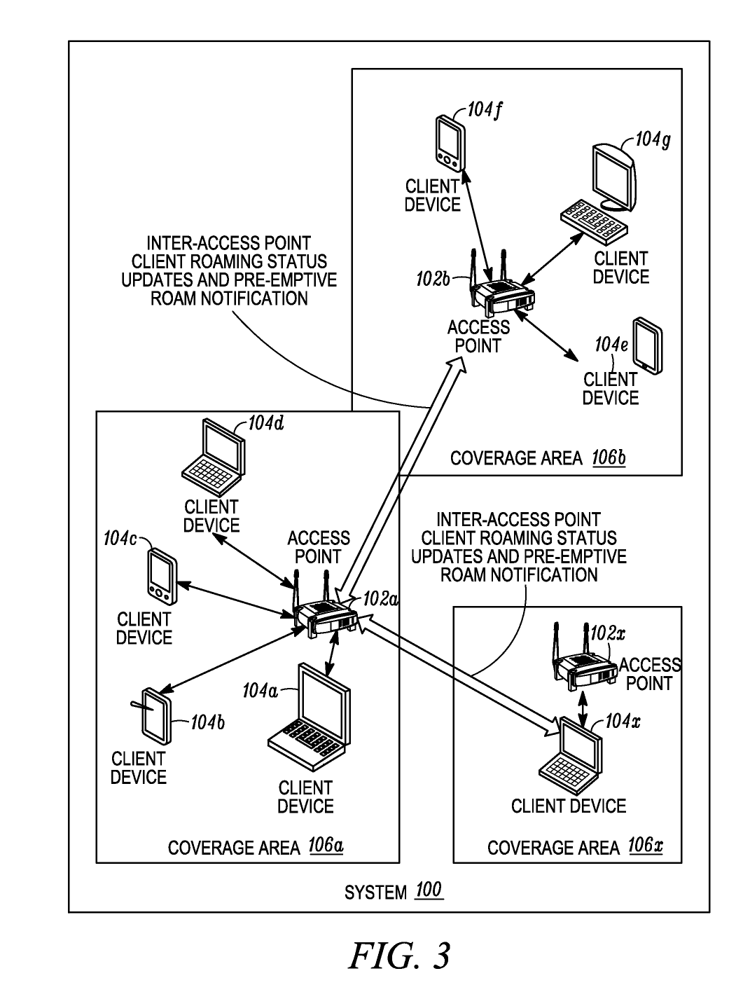

FIG. 3 is another block diagram of system 100 where a client device is likely to roam from a first access point to another access point in accordance with some embodiments. If, for example, access point 102a, determines that client device 104a might roam outside its coverage area, access point 102a may inform at least one standby access point in advance that client device 104a is likely to roam into the coverage area of the standby access point. Access point 102a might determine that client device 104a is likely roam, for example, from of an indication from client device 104a. Access point 102a might also determine that client device 104a is likely roam, for example, from indication(s) from neighboring standby access point(s). The standby access point(s) can use off channel scanning and transmit mechanisms to communicate with client device 104a before client device 104a roams into a coverage area of a standby access point. Alternately, access point 102a might also determine that client device 104a is likely roam, for example, from statistics access point 102a keeps about its link with client device 104a. Subsequent to determining that client device 104a might roam outside coverage area 106a to either, for example, coverage area 106b or 106x, access point 102a may co-ordinate the exchange of sounding packets between client device 104a and access point 102b and 102x to setup the steering matrix for the beam from access point 102b or 102x to client device 104a, depending on whether client device 104a moves to coverage area 106b or 106x. As shown in FIG. 3, access point 102a may exchange, with access points 102b and 102x, inter-access point client roaming status updates and pre-emptive roam notifications.

Therefore, beamforming may occur on a link between client device 104a and access point 102b or 102x as soon as client device 104a roams to coverage area 106b or 106x. When client device 104a is roaming to, for example, coverage area 106b, this is a period of time when client device 104a is on the fringes of the coverage areas of 106a and 106b. During this period, the additional signal boost from beamforming from access point 102b to client device 104a is beneficial in improving the signal received by client device 104a from access point 102b.

In one embodiment, the pre-emptive beamforming link between client device 104a and a standby access point may be established all the time. In other words, there may always be at least one standby access point with which client device 104a has a beam-forming setup ‘ready-to-go’ at any point in time. This may require client device 104a to continuously track its standby access point(s), and also the standby access point(s) to continuously track client device 104a even though there is no 802.11 association between the standby access point(s) and the client device.

The continuous link between at least one standby access point and client device 104a may be pre-established depending on the tradeoff between the overhead associated with pre-establishing the link between client device 104a and the standby access point and tolerance for loss of data if the link is not pre-established. In one embodiment, a pre-emptive beamforming link between client device 104a and a standby access point, say access point 102b, may be established when client device 104a is likely to roam to coverage area 106b. Client device 104a may be considered likely to roam based on, for example, a threshold in a roaming algorithm of client device 104a, driven typically by the signal strength of its associated access point, i.e., access point 102a. Client device 104a may also be considered likely to roam based on, for example, parameters such as retries and data-rates.

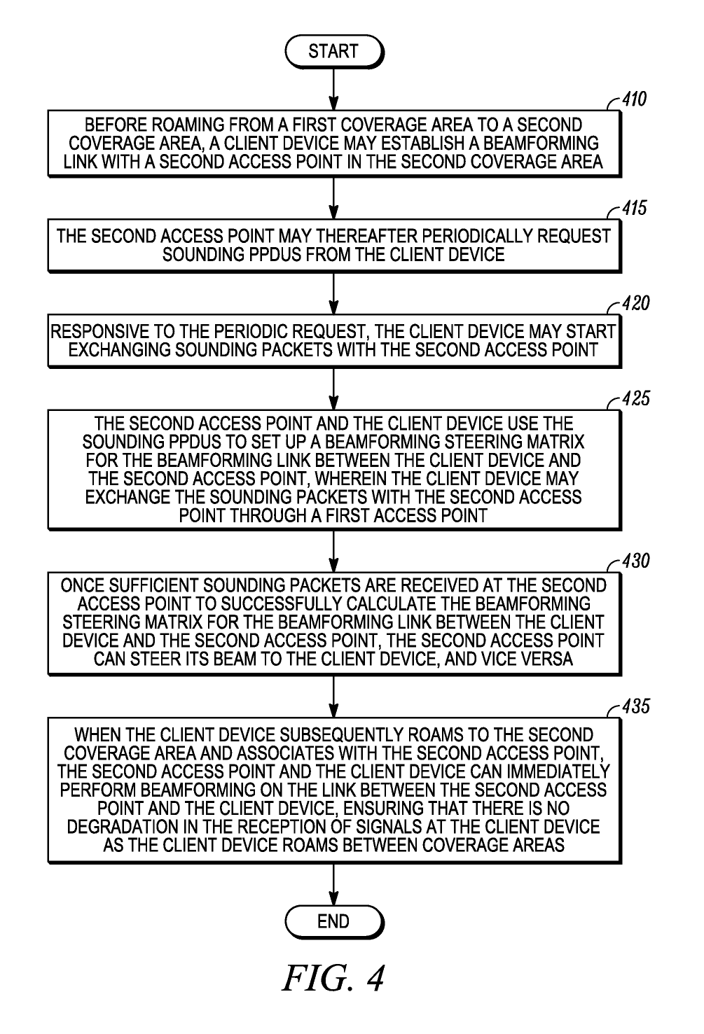

FIG. 4 is a flow diagram of how a client device pre-establishes a beamforming link with an access point in accordance with some embodiments. At 410, before roaming from a first coverage area to a second coverage area, a client device may establish a beamforming link with a second access point in the second coverage area. At 415, the second access point may thereafter periodically request sounding PPDUs from the client device. At 420, responsive to the periodic request, the client device may start exchanging sounding packets with the second access point. At 425, the second access point and the client device use the sounding PPDUs to set up a beamforming steering matrix for the beamforming link between the client device and the second access point, wherein the client device may exchange the sounding packets with the second access point through a first access point. At 430, once sufficient sounding packets are received at the second access point to successfully calculate the beamforming steering matrix for the beamforming link between the client device and the second access point, the second access point can steer its beam to the client device, and vice versa. At 435, when the client device subsequently roams to the second coverage area and associates with the second access point, the second access point and the client device can immediately perform beamforming on the link between the second access point and the client device, ensuring that there is no degradation in the reception of signals at the client device as the client device roams between coverage areas.

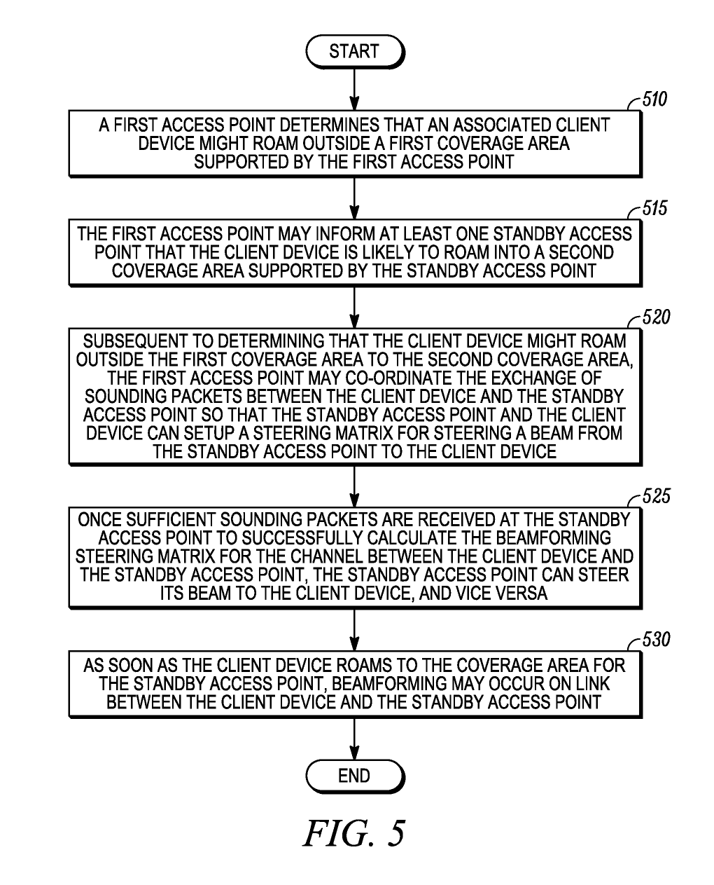

FIG. 5 is another flow diagram of how a client device pre-establishes a beamforming link with an access point in accordance with some embodiments. At 510, a first access point determines that an associated client device might roam outside a first coverage area supported by the first access point. At 515, the first access point may inform at least one standby access point that the client device is likely to roam into a second coverage area supported by the standby access point. At 520, subsequent to determining that the client device might roam outside the first coverage area to the second coverage area, the first access point may co-ordinate the exchange of sounding packets between the client device and the standby access point so that the standby access point and the client device can setup a steering matrix for steering a beam from the standby access point to the client device. At 525, once sufficient sounding packets are received at the standby access point to successfully calculate the beamforming steering matrix for the channel between the client device and the standby access point, the standby access point can steer its beam to the client device, and vice versa. At 530, as soon as the client device roams to the coverage area for the standby access point, beamforming may occur on link between the client device and the standby access point.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. For example, access point 102 and/or client device 104 of FIGS. 1-3 may comprise a set of instructions (perhaps stored in a volatile or non-volatile computer readable medium) that, when executed by a processor, perform some or all of the steps set forth in FIGS. 4 and 5 and corresponding text. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method for pre-establishing a beamforming link between a client device in a first coverage area and an access point associated with a second coverage area prior to the client device roaming to the seconding coverage area, the method comprising:
determining, by one of a first access point associated with the first coverage area or the client device in the first coverage area, that the client device is likely to roam to the second coverage area;
pre-establishing, by one of the first access point or the client device, a new beamforming link between the client device and a second access point associated with the second coverage area before the client device roams to the second coverage area and associates with the second access point by exchanging sounding data, between one of the first access point or the client device and the second access point, wherein the sounding data is used by the client device and the second access point to successfully calculate a new steering matrix for the pre-established beamforming link between the client device and the second access point; and
if the client device moves to the second coverage area, roaming, by the client device, to the second coverage area and associating with the second access point, wherein the second access point can immediately steer the pre-established beamforming link to the client device.

2. The method of claim 1, wherein pre-establishing includes adjusting the new beamforming link in response to a known location of the client device.

3. The method of claim 1, wherein if the client device does not roam to the second coverage area after a pre-determined period, the access point drops the new beamforming link.

4. The method of claim 1, wherein exchanging includes the first access point exchanging with the second access point inter-access point client roaming status updates and pre-emptive roam notifications to determine how likely the client device might roam.

5. The method of claim 1, wherein the second access point is at least one standby access point and wherein the first access point determines that the client device is likely to roam from an indication from the at least one standby access point.

6. The method of claim 5, wherein the at least one standby access point uses off channel scanning and transmit mechanisms to communicate with the client device before the client device roams into the second coverage area.

7. The method of claim 1, wherein the first access point determines that the client device is likely to roam from an indication sent in a frame from the client device.

8. The method of claim 1, wherein the first access point determines that the client device is likely to roam from an indication from statistics the first access point keeps about a current beamforming link between the first access point and the client device

9. The method of claim 1, wherein the client device is considered likely to roam based on one of the number of retries and the data rate.

10. The method of claim 1, wherein the beamforming link between the client device and the second access point is a continuous beamforming link when the client device is in the first coverage area and the beamforming link is establish at all points in time by having the client device and standby access points continuously each other even though there is no association therebetween and until roaming occurs.

11. A client device configured to pre-establish a beamforming link with an access point in another coverage area prior to roaming to the other coverage area, the client device comprising:
a processor configured to:
determine that the client device associated with a first access point in a first coverage area is likely to roam to a second coverage area;
pre-establish a new beamforming link between the client device and a second access point associated with the second coverage area before the client device roams to the second coverage area and associates with the second access point by the exchange of sounding data with the second access point, wherein the sounding data is used by the client device and the second access point to successfully calculate a new steering matrix for the pre-established beamforming link between the client device and the second access point; and
if the client device roams to the second coverage area, associate with the second access point, wherein the second access point can immediately steer the pre-established beamforming link to the client device.

12. The client device of claim 11, wherein during the exchange, the client device is configured to receive at least one request for a sounding data unit from the second access point or wherein the client device is configured to send at least one request for the sounding data unit to the second access point, wherein the sounding data unit is used to calculate the steering matrix for the beamforming link.

13. The client device of claim 11, wherein during the exchange, the client device is configured to exchange the sounding data unit through the first access point.

14. The a client device of claim 11, wherein the client device is associated with the first access point during the exchanging and associated with the second access point after the roaming.

15. The client device of claim 11, wherein the second access point is at least one standby access point and wherein the first access point determines that the client device is likely to roam from an indication from the at least one standby access point.

16. An access point comprising:
a processor configured to:
determine that a client device associated with the access point in a first coverage area is likely to roam to a second coverage area;
determine that a new beamforming link is pre-established between the client device and a second access point associated with the second coverage area before the client device roams to the second coverage area and associates with the second access point by the exchange of sounding data associated with the client device and the second access point, wherein the sounding data are used by the client device and the second access point to calculate a new steering matrix for the pre-established beamforming link; and
wherein if the client device roams to the second coverage area, the client device associates with the second access point, and the second access point can immediately steer the pre-established beamforming link to the client device.

17. The access point of claim 16, wherein the access point is configured to determine that the client device is likely to roam from an indication from the client device.

18. The access point of claim 16, wherein the access point is configured to determine that the client device is likely to roam from an indication from statistics the access point keeps about a current beamforming link between the access point and the client device.

19. The access point of claim 16, wherein during the exchange of sounding data, the access point is configured to coordinate the exchange between the client device and the second access point.

20. The access point of claim 16, further configured to maintain a continuous beamforming link between the client device and the second access point when the client device is in the first coverage area.
